(19) United States
(12) Patent Application Publication
(10) Pub. No.: US 2020/0172766 A1
(43) Pub. Date: Jun. 4, 2020

(54) DOUBLE-SIDED ADHESIVE SHEET WITH LINERS

(71) Applicant: SHARP KABUSHIKI KAISHA, Sakai City, Osaka (JP)

(72) Inventor: KENICHIROH TSUCHIDA, Sakai City, Osaka (JP)

(21) Appl. No.: 16/614,522

(22) PCT Filed: May 17, 2018
(86) PCT No.: PCT/JP2018/019020

§ 371 Date: Nov. 18, 2019

(30) Foreign Application Priority Data
May 24, 2017 (JP) 2017-102695

(51) Int. Cl. C09J 7/40; B32B 7/06

(52) U.S. Cl. CPC C09J 7/403; B32B 7/06; C09J 2203/318; B32B 2457/202; B32B 2405/00

(57) ABSTRACT

A double-sided adhesive sheet with liners includes: a double-sided adhesive sheet of which both surfaces includes adhesive faces; a first release liner that is affixed to the one adhesive face in a peelable state and includes a first release face having a low peel strength; and a second release liner that is affixed to the other adhesive face in a peelable state and includes a second release face having a higher peel strength than that of the first release face. The first release liner is arranged on a portion overlapping a part of a peripheral edge of the double-sided adhesive sheet in a two-dimensional view and includes a non-intimate contact portion that does not come into intimate contact with the one adhesive face.

### TECHNICAL FIELD

The present invention relates to a double-sided adhesive sheet with liners.

### BACKGROUND ART

Optical adhesive sheets (Optical Clear Adhesive) have been utilized for affixing liquid crystal panels and other members (for example, protective covers and touch panels) to each other. Such a kind of adhesive sheet is a double-sided adhesive type with both surfaces provided with adhesive faces, and a release liner is affixed in order to protect each adhesive face in a state prior to use.

For example, a double-sided adhesive sheet (layered body) with liners, having two adhesive faces affixed with the release liners of which the peel strengths (adhesive strengths to adhesive faces) are different from each other, is known as described in Patent Document 1. In the double-sided adhesive sheet with the liners, the release liners can be peeled from the double-sided adhesive sheet in increasing order of peel strength. In other words, in the double-sided adhesive sheet with the liners, the one release liner having the lower peel strength can be selectively (preferentially) peeled from the double-sided adhesive sheet.

### RELATED ART DOCUMENT

### Patent Document

[Patent Document 1] Japanese Unexamined Patent Application Publication No. 2010-58327

### Problem to be Solved by the Invention

In the case of attempting to first peel one release liner prepared to have a lower peel strength in advance, it has been possible to earlier peel the other release liner, even if the release liners of which the peel strengths are different from each other are disposed on two adhesive faces in advance, like the above-described double-sided adhesive sheet with the liners. This is presumed to be because in a process of manufacturing the double-sided adhesive sheet with the liners, an intimate contact property between an adhesive face of the double-sided adhesive sheet and the release liner prepared to have a higher peel strength in advance is locally decreased under the influence of an external force in working or the like, and a portion at which the peel strengths of the two release liners hardly differ from each other is locally formed.

If it is impossible to selectively peel the one release liner, for example, the double-sided adhesive sheet is pulled together with the release liners in the state of sticking to the two release liners, and, as a result, defectiveness such as a wrinkle or breaking might occur in the double-sided adhesive sheet.

### DISCLOSURE OF THE PRESENT INVENTION

An object of the present invention is to provide a double-sided adhesive sheet with liners, from which one release liner can be first peeled with reliability.

### Means for Solving the Problem

A double-sided adhesive sheet with liners according to the present invention includes: a double-sided adhesive sheet of which both surfaces include adhesive faces; a first release liner that is affixed to the one adhesive face in a peelable state, and includes a first release face having a low peel strength; and a second release liner that is affixed to the other adhesive face in a peelable state, and includes a second release face having a higher peel strength than that of the first release face, wherein the first release liner is arranged on a portion overlapping a part of a peripheral edge of the double-sided adhesive sheet in a two-dimensional view, and includes a non-intimate contact portion that does not come into intimate contact with the one adhesive face.

### Advantageous Effect of the Invention

In accordance with the present invention, there can be provided a double-sided adhesive sheet with liners, from which one release liner can be first peeled with reliability.

### BRIEF DESCRIPTION OF THE DRAWINGS

FIG. 1 is a plan view of a double-sided adhesive sheet with liners according to First embodiment of the present invention.

FIG. 2 is a plan view of an enlarged part of the double-sided adhesive sheet with liners illustrated in FIG. 1.

FIG. 3 is a cross-sectional view taken along the line A-A of FIG. 2.

FIG. 4 is an explanatory diagram illustrating a state in which a first release liner is peeled from a double-sided adhesive sheet with liners.

FIG. 5 is an exploded perspective view of a layered body including a double-sided adhesive sheet, a liquid crystal panel, and a protective cover.

FIG. 6 is an explanatory diagram schematically illustrating a raw layered product including a raw second release liner, a raw double-sided adhesive sheet, and a raw laminate.

FIG. 7 is an explanatory diagram schematically illustrating a raw layered product in a state in which a raw laminate and a raw double-sided adhesive sheet are divided into several pieces.

FIG. 8 is an explanatory diagram schematically illustrating a raw layered product including a raw first release liner, several divided raw double-sided adhesive sheets, and a raw second release liner.

FIG. 9 is an explanatory diagram illustrating a state in which several double-sided adhesive sheets with liners are obtained.

FIG. 10 is a plan view of an enlarged part of a double-sided adhesive sheet with liners according to Second embodiment.

FIG. 11 is a cross-sectional view taken along the line B-B of FIG. 10.

### BEST MODES FOR CARRYING OUT THE INVENTION

### First Embodiment

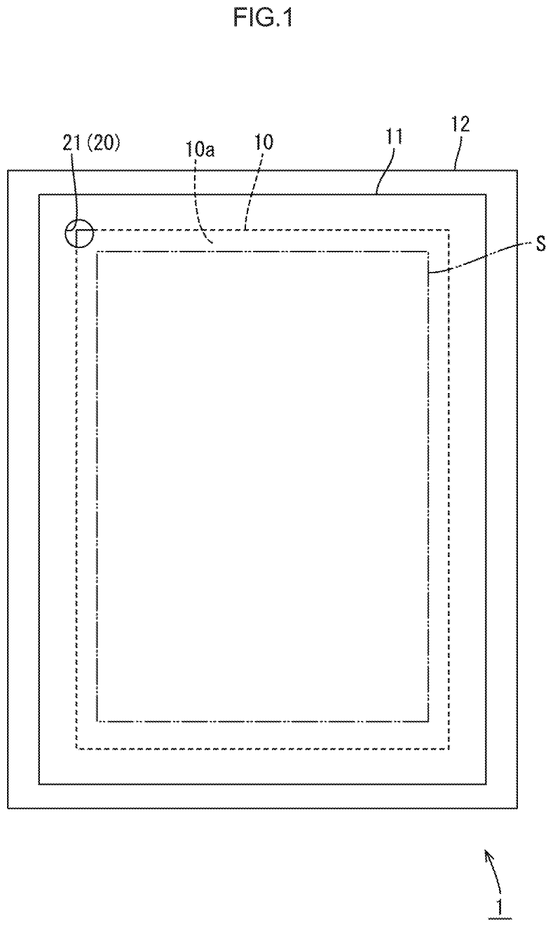

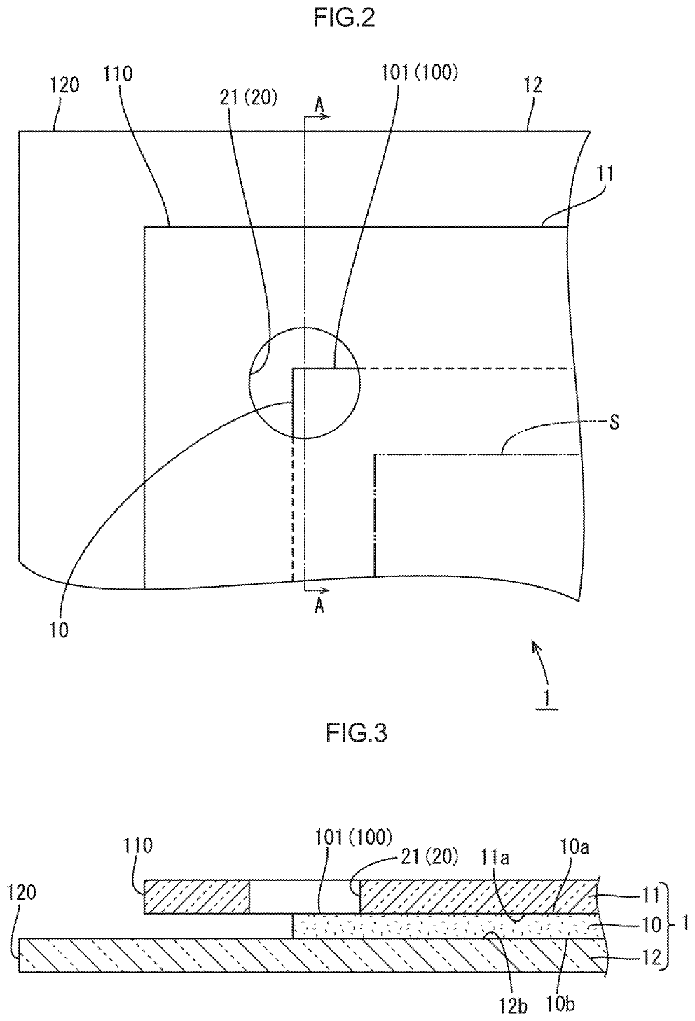

A double-sided adhesive sheet 1 with liners according to First embodiment of the present invention will be described below with reference to FIG. 1 to FIG. 9. The double-sided adhesive sheet 1 with liners of the present embodiment is used for affixing a liquid crystal panel (an example of a display panel) and a protective cover to each other, as discussed later. FIG. 1 is a plan view of the double-sided adhesive sheet 1 with liners according to First embodiment of the present invention, FIG. 2 is a plan view of an enlarged part of the double-sided adhesive sheet 1 with liners illustrated in FIG. 1, and FIG. 3 is a cross-sectional view taken along the line A-A of FIG. 2.

The double-sided adhesive sheet 1 with liners includes a double-sided adhesive sheet 10, a first release liner 11, and a second release liner 12. The double-sided adhesive sheet 1 with liners has a configuration in which the first release liner 11 is affixed to one adhesive face 10a of the double-sided adhesive sheet 10 in a peelable state, and the second release liner 12 is affixed to another adhesive face 10b.

The double-sided adhesive sheet (adhesive layer) 10 is a double-sided adhesive type adhesive sheet of which both surfaces include the adhesive faces 10a and 10b. In FIG. 1 and FIG. 2, the one adhesive face 10a of the double-sided adhesive sheet 10 is arranged in the front side of each figure, and the other adhesive face 10b (not illustrated in FIG. 1 and FIG. 2) is arranged in the rear side of each figure. The one adhesive face 10a is arranged in the upper side of FIG. 3, and the other adhesive face 10b is arranged in the lower side thereof. In other words, the adhesive face 10a is arranged on the opposite side of the adhesive face 10b.

The double-sided adhesive sheet 10 is not particularly limited as long as exhibiting sufficient adhesive strength to an adherend such as a liquid crystal panel or a protective cover (cover glass) and having such optical characteristics (for example, light transmissiveness) as to enable use in optical applications (for example, for use in a liquid crystal display device). For example, a commercially available double-sided adhesive type optical adhesive sheet can be used as the double-sided adhesive sheet 10. A material included in the double-sided adhesive sheet 10 is not particularly limited, and, for example, a composition including an acrylic adhesive as a main constituent is used. The thickness of the double-sided adhesive sheet 10 is not particularly limited as long as the object of the present invention is met, and, for example, the upper limit value thereof is set at 300 μm or less (preferably 200 μm or less, more preferably 100 μm or less, and still more preferably 50 μm or less). The lower limit value of the thickness of the double-sided adhesive sheet 10 is set at, for example, 10 μm or more, and preferably 20 μm or more.

The double-sided adhesive sheet 10 has a rectangular shape (an example of a quadrangular shape) in a two-dimensional view, as illustrated in FIG. 1. The size of the double-sided adhesive sheet 10 is set to be larger than that of the display region of a liquid crystal panel described later. In FIG. 1, a region S corresponding to the display region of the liquid crystal panel is indicated by a chain double-dashed line. As illustrated in FIG. 1, the double-sided adhesive sheet 10 is a size larger than that of the region S, and the double-sided adhesive sheet 1 with liners is in a form in which the region S is within the double-sided adhesive sheet 10.

The first release liner 11 is a member which is affixed to the adhesive face 10a in a peelable state in order to protect the one adhesive face 10a in a state prior to use of the double-sided adhesive sheet 10. A first release face 11a is formed on a surface, affixed to the adhesive face 10a, of the first release liner 11, which generally has a sheet shape. The first release liner 11 is affixed to the double-sided adhesive sheet 10 in a form in which the first release face 11a comes into intimate contact with the adhesive face 10a. As illustrated in FIG. 11, the first release liner 11 has a rectangular shape larger than the double-sided adhesive sheet 10 in a two-dimensional view, and the double-sided adhesive sheet 1 with liners is in a form in which the double-sided adhesive sheet 10 is within the first release liner 11.

In the first release liner 11, the first release face 11a is formed by subjecting, for example, one surface of a sheet made of a synthetic resin to release treatment. Examples of the synthetic resin utilized in the sheet include polyester resins such as polyethylene terephthalate (PET). Examples of the release treatment to which one surface of the sheet is subjected include treatment in which a known release agent such as, for example, a silicone-based release agent or a fluorine-based release agent is applied to form a release layer.

The second release liner 12 is a member which is affixed to the adhesive face 10b in a peelable state in order to protect the other adhesive face 10b of the double-sided adhesive sheet 10 in a state prior to use of the double-sided adhesive sheet 10. A second release face 12b is formed on a surface, affixed to the adhesive face 10b, of the second release liner 12, which generally has a sheet shape, like the first release liner 11. The second release liner 12 is affixed to the double-sided adhesive sheet 10 in a form in which the second release face 12b comes into intimate contact with the adhesive face 10b. As illustrated in FIG. 1, the second release liner 12 has a larger rectangular shape than the double-sided adhesive sheet 10 in a two-dimensional view. In the case of the present embodiment, the second release liner 12 is particularly set to be a size larger than that of the first release liner 11. Therefore, a peripheral edge 120 of the second release liner 12 is arranged outside a peripheral edge 110 of the first release liner 11, as illustrated in FIG. 1 and FIG. 2.

In the second release liner 12, like the first release liner 11, the second release face 12b is formed by subjecting, for example, one surface of a sheet made of a synthetic resin to known release treatment. The thickness of the first release liner 11 and the thickness of the second release liner 12 are not particularly limited as long as the object of the present invention is met. In the case of the present embodiment, the thicknesses are set to be equal to each other.

The peel strength (adhesive strength to the adhesive face 10b) of the second release face 12b of the second release liner 12 is set to be higher than the peel strength (adhesive strength to the adhesive face 10a) of the first release face 11a of the first release liner 11, and a difference between the peel strengths is set.

As described above, the double-sided adhesive sheet 1 with liners is configured so that the first release liner 11 and the second release liner 12 can be peeled from the double-sided adhesive sheet 10 in order of the first release liner 11 and the second release liner 12 by setting the difference between the peel strengths of the first release face 11a and the second release face 12b.

The peel strength of each of the first release face 11a and the second release face 12b can be regulated by setting, for example, the conditions (for example, a material, a thickness, and the like) of a release layer formed by release treatment, and the like, as appropriate. Such a peel strength (adhesive strength to the adhesive face) can be measured by, for example, a 180° peel test (test piece width: 20 mm, tension speed: 300 mm/min, and peel angle: 180 degrees) using a tensile machine.

In the first release liner 11, a non-intimate contact portion 20 that does not come into intimate contact with the one adhesive face 10a is formed on a portion overlapping, in a two-dimensional view, a corner 101 which is a part of a peripheral edge 100 of the double-sided adhesive sheet 10. Since the double-sided adhesive sheet 1 with liners includes the first release liner 11 including such a non-intimate contact portion 20, it is possible to earlier peel the first release liner 11 with reliability.

The non-intimate contact portion 20 is disposed on the portion overlapping, in a two-dimensional view, the corner 101 which is a part of the peripheral edge 100 of the double-sided adhesive sheet 10, in the first release liner 11. The non-intimate contact portion 20 of the present embodiment includes a hole 21 passing through the first release liner 11 in a thickness direction. The non-intimate contact portion 20 does not include a portion (i.e., the first release face 11a) coming into intimate contact with the adhesive face 10a of the double-sided adhesive sheet 10, and does not have an adhesive strength to the adhesive face 10a.

The non-intimate contact portion 20 (hole 21) of the present embodiment has a circular shape in a two-dimensional view. The shape of the non-intimate contact portion 20 (hole 21) is not limited as long as the object of the present invention is met. As illustrated in FIG. 2, the corner 101 of the double-sided adhesive sheet 10 is within the non-intimate contact portion 20, and the corner 101 is in the state of being exposed from the interior of the hole 21 included in the non-intimate contact portion 20. As well as the corner 101, a part of the second release liner 12 arranged outside the corner 101 is in the state of being exposed from the interior of the non-intimate contact portion 20 (hole 21).

The corner 101 (an example of the peripheral edge 100) of the double-sided adhesive sheet 10 exposed from the non-intimate contact portion 20 is in a state in which a side, closer to the one adhesive face 10a, of the corner 101 does not come into intimate contact with the first release liner 11 (non-intimate contact portion 20) but a side, closer to the adhesive face 10b, of the corner 101 comes into intimate contact with the second release face 12b of the second release liner 12.

The non-intimate contact portion 20 is arranged outside the region S corresponding to the display region of the liquid crystal panel. In other words, the non-intimate contact portion 20 is placed at a position corresponding to a non-display region arranged outside (around) the display region of the liquid crystal panel. Therefore, even in a case in which a part of the double-sided adhesive sheet 10 is exposed from the interior of the non-intimate contact portion 20, the part does not influence the display quality of the liquid crystal panel, and therefore, the case is not problematic.

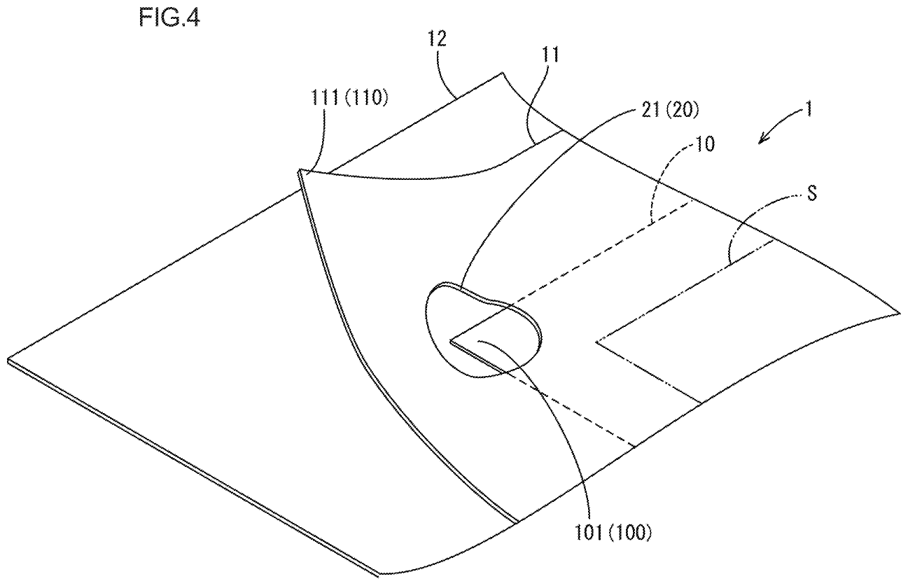

FIG. 4 is an explanatory diagram illustrating a state in which the first release liner 11 is peeled from the double-sided adhesive sheet 1 with liners. The corner 101 of the double-sided adhesive sheet 10 is in a state in which the one adhesive face 10a is arranged on the non-intimate contact portion 20, and the other adhesive face 10b comes into intimate contact with the second release liner 12. The non-intimate contact portion 20 allows formation of an origin (peeling start point) for facilitating peeling the first release liner 11, and the corner 101 of the double-sided adhesive sheet 10 is in a state in which the one adhesive face 10a has already been separated from the first release liner 11 in a state prior to peeling of the first release liner 11. Therefore, only the first release liner 11 is reliably peeled while the second release liner 12 is in the state of coming into intimate contact with the double-sided adhesive sheet 10 in the case of pulling a peripheral edge 110 (corner 111) of the first release liner 11, near such a corner 101 of the double-sided adhesive sheet 10 (non-intimate contact portion 20).

In the case of the present embodiment, the peripheral edge 120 of the second release liner 12 projects outward from the peripheral edge 110 of the first release liner 11, it is easy to press against the second release liner 12 at the time of peeling the first release liner 11, and an operator (or a peeling device) easily pinches the peripheral edge 110 (corner 111) of the first release liner 11.

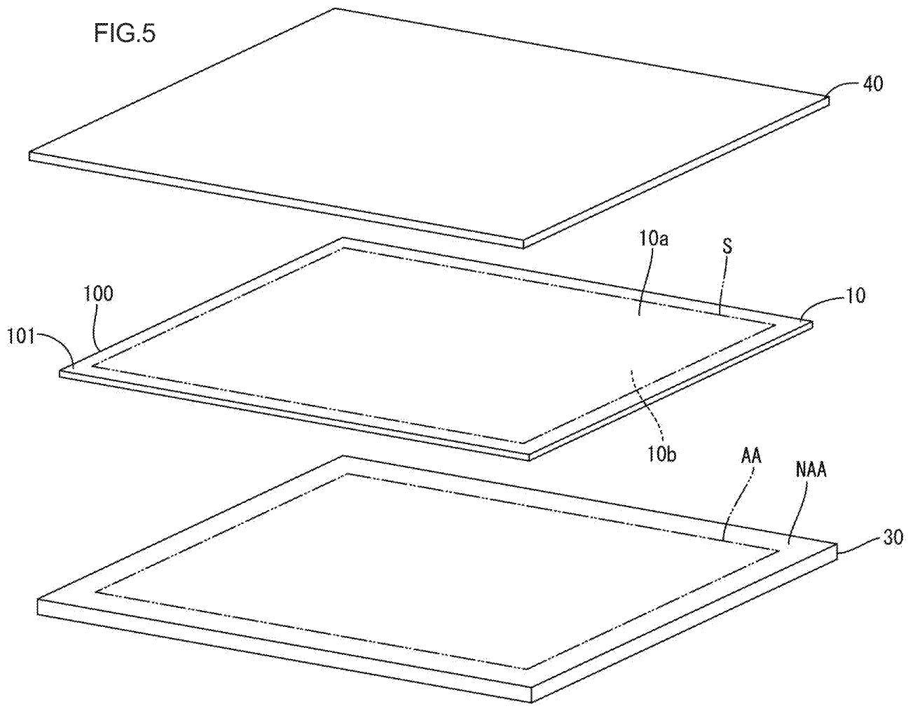

FIG. 5 is an exploded perspective view of a layered body including the double-sided adhesive sheet 10, a liquid crystal panel 30, and a protective cover 40. An example of a step of affixing the liquid crystal panel 30 and the protective cover 40 to each other using the double-sided adhesive sheet 1 with liners will now be described. First, the first release liner 11 is peeled from the double-sided adhesive sheet 1 with liners to expose the one adhesive face 10a. Then, the double-sided adhesive sheet 10 in a state, in which the adhesive face 10a is exposed and the second release liner 12 is affixed, is affixed in a form in which the adhesive face 10a comes into intimate contact with a surface of the protective cover 40. Then, the second release liner 12 is peeled from the double-sided adhesive sheet 10 in the state of being affixed to the protective cover 4, to expose the other adhesive face 10b. The exposed adhesive face 10b is affixed to the liquid crystal panel 30 to affix the protective cover 40 and the liquid crystal panel 30 to each other via the double-sided adhesive sheet 10.

A relationship between the non-intimate contact portion 20 of the double-sided adhesive sheet 1 with liners and the display region AA and non-display region NAA of the liquid crystal panel 30 will now be described with reference to FIG. 5 and the like. As illustrated in FIG. 5, the liquid crystal panel (an example of the display panel) 30 includes the display region AA having a rectangular shape in a two-dimensional view in a central side, and includes the non-display region NAA having a frame shape surrounding the display region AA in the outer side of the display region AA. The double-sided adhesive sheet 10 is affixed to the liquid-crystal display panel 30 so that the peripheral edge 100 overlaps the non-display region NAA in a two-dimensional view.

The non-intimate contact portion 20 of the double-sided adhesive sheet 1 with liners (first release liner 11) illustrated in FIG. 1 to FIG. 4 is arranged in a portion overlapping, in a two-dimensional view, a part (corner 101) of the peripheral edge 100 of the double-sided adhesive sheet 10, overlapping the non-display region NAA of the liquid crystal panel 30. In other words, an adhesive face 20a exposed from the non-intimate contact portion 20 is affixed to a portion corresponding to the non-display region NAA in a surface of the liquid crystal panel 30. Therefore, the display quality of the liquid crystal panel 30 is not influenced even in a case in which fine dust or the like settles on the exposed adhesive face 20a.

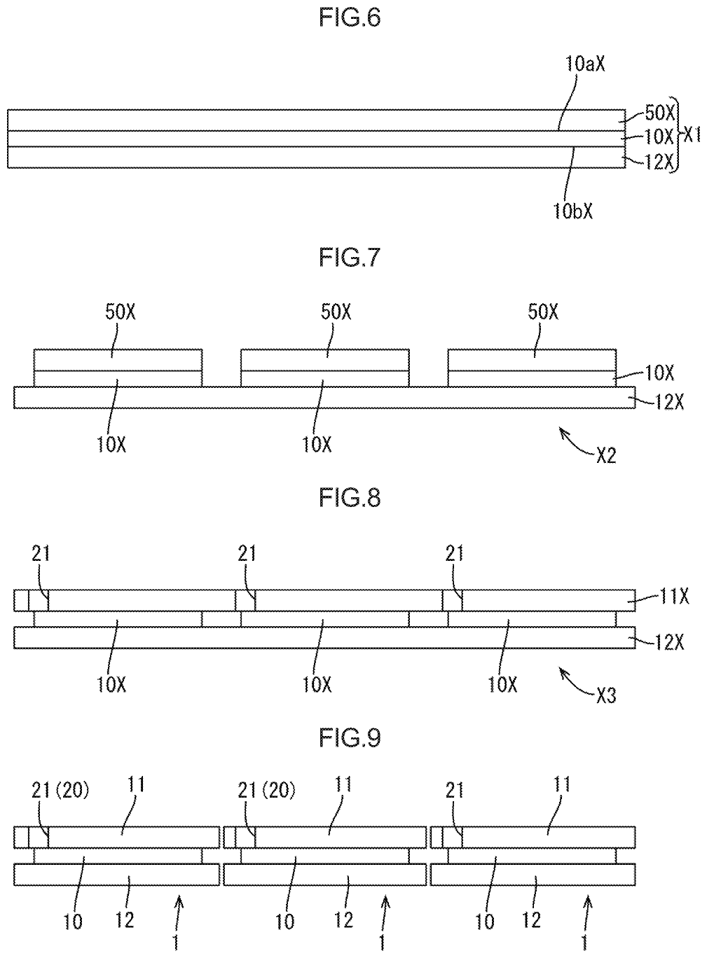

An example of a method of producing the double-sided adhesive sheet 1 with liners will now be described with reference to FIG. 6 to FIG. 9. FIG. 6 is an explanatory diagram schematically illustrating a raw layered product X1 including a raw second release liner 12X, a raw double-sided adhesive sheet 10X, and a raw laminate 50X. The production method of the present embodiment is a method in which the several double-sided adhesive sheets 1 with liners are produced in a mass from the raw layered product X1 while performing predetermined working of the raw layered product X1. As illustrated in FIG. 6, the raw layered product X1 including the raw second release liner 12X, the raw double-sided adhesive sheet 10X, and the raw laminate 50X is prepared. The raw laminate 50X is temporarily affixed to one adhesive face 10aX of the raw double-sided adhesive sheet 10X in a peelable state. The raw laminate 50X includes a laminate film which can be easily peeled from the adhesive face 10aX. In contrast, the raw second release liner 12X is affixed to the other adhesive face 10bX of the raw double-sided adhesive sheet 10X. In such a raw layered product X1, the raw laminate 50X and the raw double-sided adhesive sheet 10X are first cut using a predetermined cutting device so as to be divided into several pieces. In such a case, the raw second release liner 12X is not cut.

FIG. 7 is an explanatory diagram schematically illustrating a raw layered product X2 in a state in which the raw laminate 50X and the raw double-sided adhesive sheet 10X are divided into several pieces. FIG. 7 illustrates a state in which several layered products including the raw laminates 50X and the raw double-sided adhesive sheets 10X in the state of being divided are formed on a surface of the raw second release liner 12X. In such a manner, the raw laminate 50X and the raw double-sided adhesive sheet 10X are divided into several pieces on the raw second release liner 12X, and the raw laminates 50X are then peeled from the raw double-sided adhesive sheets 10X. In place of the peeled raw laminates 50X, a raw first release liner 11X is affixed to the raw double-sided adhesive sheets 10X. FIG. 8 is an explanatory diagram schematically illustrating a raw layered product X3 including the raw first release liner 11X, the several divided raw double-sided adhesive sheets 10X, and the raw second release liner 12X.

In the raw first release liner 11X, which is prepared in advance prior to such a swap as described above, several holes 21 are formed by performing punching working of the predetermined sites of a sheet made of a synthetic resin, of which one surface is subjected to release treatment. The raw first release liner 11X is affixed to the raw double-sided adhesive sheets 10X in a state in which the several holes 21 are assigned so as to overlap, in a two-dimensional view, the corners of the several divided raw double-sided adhesive sheets 10X, respectively. Such a raw layered product X3 is cut in the form of being stamped so as to be divided into several double-sided adhesive sheets 1 with liners using predetermined cutting means (for example, a cutter). FIG. 9 is an explanatory diagram illustrating a state in which the several double-sided adhesive sheets 1 with liners are obtained.

The cutting of the raw layered product X3 is performed by, for example, moving the cutting means from the upper portion to lower table side of the raw layered product X3 in the state of being placed on the predetermined table. After the cutting, the cutting means is moved in a reverse direction (i.e., from the lower portion to the upper portion). Due to such movement of the cutting means, end faces of the double-sided adhesive sheets 10 in the finally obtained double-sided adhesive sheets 1 with liners may be pushed downward (toward second release liners 12) or may be reversely pulled upward (toward first release liners 11). Such pushing or pulling is prone to occur particularly in the corners of the double-sided adhesive sheets 1 with liners.

When such pushing or pulling of an end face of a double-sided adhesive sheet 10 as described above occurs, a decrease in the peel strength of a second release liner 12, or the like may occur in a portion in which such pushing or pulling occurs, thereby locally causing the peel strength of a first release liner 11 to be equivalent to the peel strength of the second release liner 12, or the peel strength of the first release liner 11 to be higher than the peel strength of the second release liner 12. In other words, the peel strengths may become equivalent to each other, or the magnitude relationship (strength relationship) of the peel strengths may be reversed. In a case in which such a portion exists, the first release liner 11 may be prevented from being peeled from the double-sided adhesive sheet 10, and the double-sided adhesive sheet 10 may be pulled together with the first release liner 11, thereby causing the deformation of the double-sided adhesive sheet 10, or the like, when the first release liner 11 is attempted to be peeled.

With regard to the double-sided adhesive sheet 1 with liners of the present embodiment, the non-intimate contact portion 20 is disposed in the predetermined site of the first release liner 11 in order to reliably prevent such troubles as described above.

### Second Embodiment

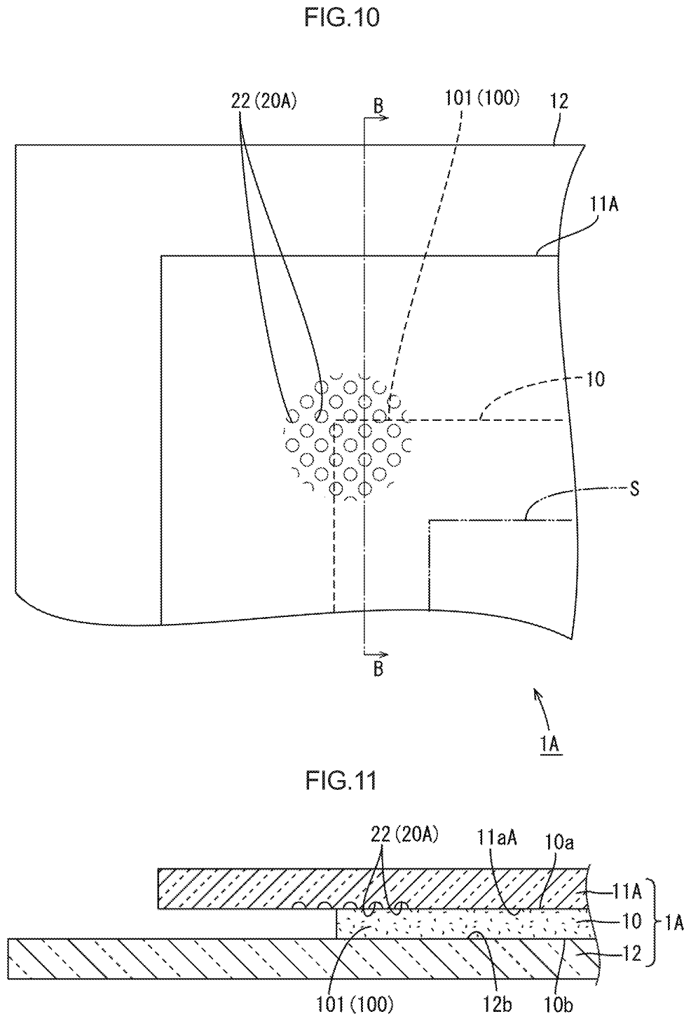

A double-sided adhesive sheet 1A with liners according to Second embodiment of the present invention will now be described with reference to FIG. 10 and FIG. 11. FIG. 10 is a plan view of an enlarged part of the double-sided adhesive sheet 1A with liners according to Second embodiment, and FIG. 11 is a cross-sectional view taken along the line B-B of FIG. 10. The same components as that of the above First embodiment are denoted by the same reference characters in FIG. 10 and FIG. 11, and the detailed descriptions thereof are omitted.

The double-sided adhesive sheet 1A with liners of the present embodiment includes a first release liner 11A including a non-intimate contact portion 20A including several recesses (dimples) 22, in place of the first release liner 11 of First embodiment. Such formation is performed in a portion, in a two-dimensional view, overlapping a part (corner 101) of a peripheral edge 100 of a double-sided adhesive sheet 10, in a side closer to a first release face 11aA of the first release liner 11A. The recesses 22 are formed as appropriate using known embossing or the like.

Since the non-intimate contact portion 20A of the present embodiment does not pass through the first release liner 11A in a thickness direction like the above First embodiment, an adhesive face 10a of the double-sided adhesive sheet 10 is not exposed from the non-intimate contact portion 20A. Therefore, in the case of the present embodiment, the first release liner 11A having a low peel strength can be earlier peeled with reliability like the above First embodiment, and, in addition, the deposition of a foreign substance and the generation of soil or the like on the adhesive face 10a of a portion overlapping the non-intimate contact portion 20A in a two-dimensional view are suppressed. The non-intimate contact portion 20A of the present embodiment is also arranged outside a region S corresponding to the display region of a liquid crystal panel, like First embodiment.

Unlike a fine portion formed by, e.g., release treatment of a release liner, the recesses 22 in the non-intimate contact portion 20A are formed on the first release face 11aA of the first release liner 11A so that a peel strength becomes generally zero.

### Other Embodiments

The present invention is not limited to the embodiments explained by the above descriptions and with reference to the drawings, and, for example, the following embodiments are also included in the technical scope of the present invention.

(1) The non-intimate contact portion is formed on the first release liner so as to overlap the corner of the double-sided adhesive sheet in a two-dimensional view in the embodiments described above; however, the present invention is not limited thereto, and a non-intimate contact portion may be formed on, for example, a portion (peripheral edge) along a side of a double-sided adhesive sheet. However, the non-intimate contact portion is preferably disposed so as to overlap a corner of the double-sided adhesive sheet in a two-dimensional view from the viewpoint of reliably peeling a first release liner.

(2) The single non-intimate contact portion is formed on the first release liner in the embodiments described above; however, the present invention is not limited thereto, and two or more non-intimate contact portions may be formed. For example, a plurality of non-intimate contact portions may be formed in a form corresponding to a plurality of corners of a double-sided adhesive sheet.

(3) The second release liner is set to be larger than the first release liner in the embodiments described above; however, the present invention is not limited thereto, and, for example, a first release liner and a second release liner may have the same size, or a second release liner may be larger than a first release liner.

(4) The non-intimate contact portion is formed of the aggregate of the several recesses in the above Second embodiment; however, the present invention is not limited, and, for example, a non-intimate contact portion may be formed of one recess. In another embodiment, a through-hole for ventilation, or the like may be disposed in a non-intimate contact portion.

(5) The non-intimate contact portion has a circular shape in a two-dimensional view in the embodiments described above; however, the shape of a non-intimate contact portion is not particularly limited as long as the object of the present invention is met, and the shape may be, for example, a rectangular shape, a polygonal shape, an indeterminate shape, or the like.

(6) The liquid crystal panel is described as an example of a display panel in the embodiments described above; however, the double-sided adhesive sheet with liners of the present invention may be utilized for another display panel (for example, an organic EL panel).

### EXPLANATION OF SYMBOLS

1: Double-sided adhesive sheet with liners
10: Double-sided adhesive sheet
10a, 10b: Adhesive face
100: Peripheral edge
101: Corner
11: First release liner
11a: First release face
12: Second release liner
12b: Second release face
20: Non-intimate contact portion
21: Hole
30: Liquid crystal panel
40: Protective cover
AA: Display region
NAA: Non-display region
S: Region corresponding to display region

1. A double-sided adhesive sheet with liners, comprising:
a double-sided adhesive sheet of which both surfaces comprise adhesive faces;
a first release liner that is affixed to the one adhesive face in a peelable state, and comprises a first release face having a low peel strength; and
a second release liner that is affixed to the other adhesive face in a peelable state, and comprises a second release face having a higher peel strength than that of the first release face,
wherein the first release liner is arranged on a portion overlapping a part of a peripheral edge of the double-sided adhesive sheet in a two-dimensional view, and comprises a non-intimate contact portion that does not come into intimate contact with the one adhesive face.

2. The double-sided adhesive sheet with liners according to claim 1, wherein the non-intimate contact portion comprises a hole passing through the first release liner in a thickness direction.

3. The double-sided adhesive sheet with liners according to claim 1, wherein the non-intimate contact portion comprises one or more recesses formed on a side closer to the first release face.

4. The double-sided adhesive sheet with liners according to claim 1, wherein the non-intimate contact portion is arranged in a portion overlapping, in a two-dimensional view, a corner of the double-sided adhesive sheet in a part of the peripheral edge.

5. The double-sided adhesive sheet with liners according to claim 1, wherein the first release liner and the second release liner are larger than the double-sided adhesive sheet in a two-dimensional view.

6. The double-sided adhesive sheet with liners according to claim 5, wherein the first release liner is larger than the second release liner in a two-dimensional view.

7. The double-sided adhesive sheet with liners according to claim 1, wherein
the double-sided adhesive sheet is used in a display panel comprising a display region and a non-display region arranged around the display region, and is used so that the peripheral edge overlaps the non-display region in a two-dimensional view, and
the non-intimate contact portion is arranged in a portion overlapping, in a two-dimensional view, a part of the peripheral edge overlapping the non-display region.

8. The double-sided adhesive sheet with liners according to claim 1, wherein the double-sided adhesive sheet has a quadrangular shape in a two-dimensional view.
